(19) United States
(12) Patent Application Publication
(10) Pub. No.: US 2013/0002602 A1
(43) Pub. Date: Jan. 3, 2013

(54) Systems And Methods For Touch Screen Image Capture And Display

(76) Inventors: Suzana Apelbaum, New York, NY (US); Serena Amelia Connelly, Brooklyn, NY (US); Shachar Gillat Scott, Hoboken, NJ (US)

(21) Appl. No.: 13/463,920

(22) Filed: May 4, 2012

Related U.S. Application Data
(60) Provisional application No. 61/501,992, filed on Jun. 28, 2011.

(51) Int. Cl. G06F 3/044

(52) U.S. Cl. 345/174; 345/173

(57) ABSTRACT

Included are embodiments for touch screen image capture. Some embodiments include receiving data related to a multi-point touch from a multi-point input touch screen, the multi-point input touch screen configured to receive the multi-point touch from a user, determining, from the data related to the multi-point touch, a plurality of respective sizes of the multi-point touch that was detected by the multi-point input touch screen, and determining, from the data related to the multi-point touch, a plurality of respective shapes of the multi-point touch that was detected by each of the multi-point input touch screen. Some embodiments include combining the plurality of respective sizes to determine a total size of the multi-point touch, combining the plurality of respective shapes to determine a total shape of the multi-point touch, and rendering an image that represents the total size and the total shape of the multi-point touch.

### CROSS REFERENCE TO RELATED APPLICATION

This application claims the benefit of U.S. Provisional Application No. 61/501,992, filed Jun. 28, 2011, which is herein incorporated by reference in its entirety.

### FIELD OF THE INVENTION

The present application relates generally to systems and methods for touch screen image capture and specifically to capturing an imprint of a user's hand, foot, or other body part on a touch screen.

### BACKGROUND OF THE INVENTION

As computing becomes more advanced, many tablets, personal computers, mobile phones, and other computing devices utilize a touch screen as an input device and/or display device. The touch screen may be configured as a capacitor touch screen, resistor touch screen, and/or other touch screen and may be configured as a multi-point input touch screen to receive a plurality of input points at a time. In being configured to receive a plurality of input points at a time, the user may easily zoom, type, scroll, and/or perform other functions. However, while utilization of the multi-point input touch screen may allow for these features, oftentimes the touch screen is not utilized to maximize the device functionality.

### SUMMARY OF THE INVENTION

Included are embodiments of a method for touch screen image capture. Some embodiments include receiving data related to a multi-point touch on a multi-point input touch screen. The multi-point input touch screen may be configured to receive the multi-point touch from a user, determine, from the data related to the multi-point touch, a plurality of respective sizes of the multi-point touch that was detected by the multi-point input touch screen, and determine, from the data related to the multi-point touch, a plurality of respective shapes of the multi-point touch that was detected by the multi-point input touch screen. Some embodiments include combining the plurality of respective sizes to determine a total size of the multi-point touch, combining the plurality of respective shapes to determine a total shape of the multi-point touch, and rendering an image that represents the total size and the total shape of the multi-point touch.

Also included are embodiments of a system. Some embodiments of the system include a multi-point input touch screen that includes a plurality of sensors that collectively receives a multi-point touch from a user and a memory component that stores logic that when executed by the system causes the system to receive data related to the multi-point touch, determine a total size of the multi-point touch, and determine a total shape of the multi-point touch. In some embodiments, the logic further causes the system to render an image that represents the total size and the total shape of the multi-point touch and provide the image to the multi-point input touch screen for display.

Also included are embodiments of a non-transitory computer-readable medium. Some embodiments of the non-transitory computer-readable medium include a program that causes a computing device to receive data related to a multi-point touch from a plurality of sensors on a multi-point input touch screen, the multi-point input touch screen configured to receive the multi-point touch from a user, determine, from the data related to the multi-point touch, a plurality of respective sizes of the multi-point touch that was detected by each of the plurality of sensors, and determine, from the data related to the multi-point touch, a plurality of respective shapes of the multi-point touch that was detected by each of the plurality of sensors. In some embodiments the program causes the computing device to combine the plurality of respective sizes to determine a total size of the multi-point touch, where combining the plurality of respective sizes includes utilizing a predetermined position of each of the plurality of sensors, combine the plurality of respective shapes to determine a total shape of the multi-point touch, wherein combining the plurality of respective shapes includes utilizing the predetermined position of each of the plurality of sensors, and render a first image that represents the total size and the total shape of the multi-point touch. In still some embodiments, the program causes the computing device to provide the first image to the multi-point input touch screen for display.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing environment for touch screen image capture, according to embodiments disclosed herein;

FIG. 2 depicts a computing device that may be utilized for touch screen image capture, according to embodiments disclosed herein;

FIG. 3 depicts the computing device, utilizing a mutual capacitive touch screen configuration, according to embodiments disclosed herein;

FIG. 4 depicts a computing device utilizing a self capacitive touch screen configuration, according to embodiments disclosed herein;

FIGS. 5A-5F depict a visual representation of a process for a touch screen to determine an input, according to embodiments disclosed herein;

FIG. 6 depicts a user interface for a first touch screen image capture, according to embodiments disclosed herein;

FIG. 7 depicts a user interface for receiving a first imprint of a foot, according to embodiments disclosed herein;

FIG. 8 depicts a user interface for a second touch screen image capture, according to embodiments disclosed herein;

FIG. 9 depicts a user interface for providing a second imprint of a foot, according to embodiments disclosed herein;

FIG. 10 depicts a user interface for including the imprint of a first foot with the imprint of a second foot, according to embodiments disclosed herein;

FIG. 11 depicts a user interface for tagging a touch screen image capture, according to embodiments disclosed herein;

FIG. 12 depicts a user interface for assigning a particular tag to a touch screen image capture, according to embodiments disclosed herein;

FIG. 13 depicts a user interface for providing saving options, according to embodiments disclosed herein;

FIG. 14 depicts a user interface for providing sending options, according to embodiments disclosed herein; and

FIG. 15 depicts a flowchart for touch screen image capture, according to embodiments disclosed herein.

### DETAILED DESCRIPTION OF THE INVENTION

Embodiments disclosed herein include systems and methods for touch screen image capture. In some embodiments, the systems and methods are configured for receiving an imprint of a hand, foot, lips, ear, nose, pet paw, and/or other body part on a multi-point input touch screen that is associated with a computing device. The computing device can utilize sensing logic to determine the sizes and shapes of inputs at one or more different sensor points. The computing device can then combine these various sizes and shapes to determine a total size and shape for the imprint. From the total size and shape data, the computing device can render an image that represents the imprint. Various other options may also be provided.

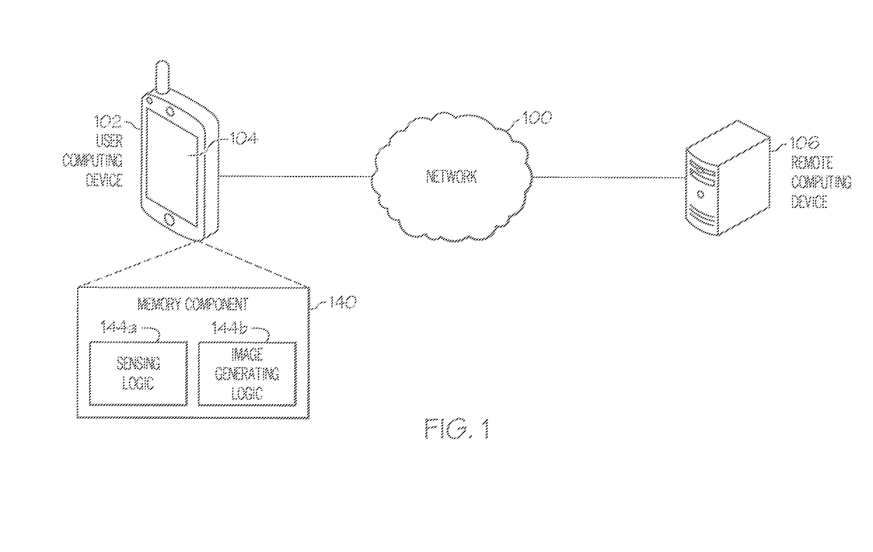

FIG. 1 depicts a computing environment for touch screen image capture, according to embodiments disclosed herein. As illustrated, a network 100 may be coupled to a user computing device 102 (which includes a multi-point touch screen, such as touch screen 104) and a remote computing device 106. The network 100 may include a wide area network and/or a local area network and thus may be wired and/or wireless. The user computing device 102 may include any portable and/or non-portable computing devices, such as personal computers, laptop computers, tablet computers, personal digital assistants (PDAs), mobile phones, etc. As discussed in more detail below, the user computing device 102 may include a memory component 140 that stores sensing logic 144a and image generating logic 144b. The sensing logic 144a may include software, hardware, and/or firmware for sensing a multi-point input on the touch screen 104 and determining the size, shape, and position of that input. Similarly, the image generating logic 144b may include software, hardware, and/or firmware for generating an image from the multi-point input and providing user interfaces and options related to that image.

Similarly, the remote computing device 106 may be configured as a server and/or other computing device for communicating information with the user computing device 102. In some embodiments, the remote computing device 106 may be configured to send and/or receive images captured from the touch screen 104.

It should be understood that while the user computing device 102 and the remote computing device 106 are represented in FIG. 1 each as a single component; this is merely an example. In some embodiments, there may be numerous different components that provide the described functionality. However, for illustration purposes, single components are shown in FIG. 1 and described herein.

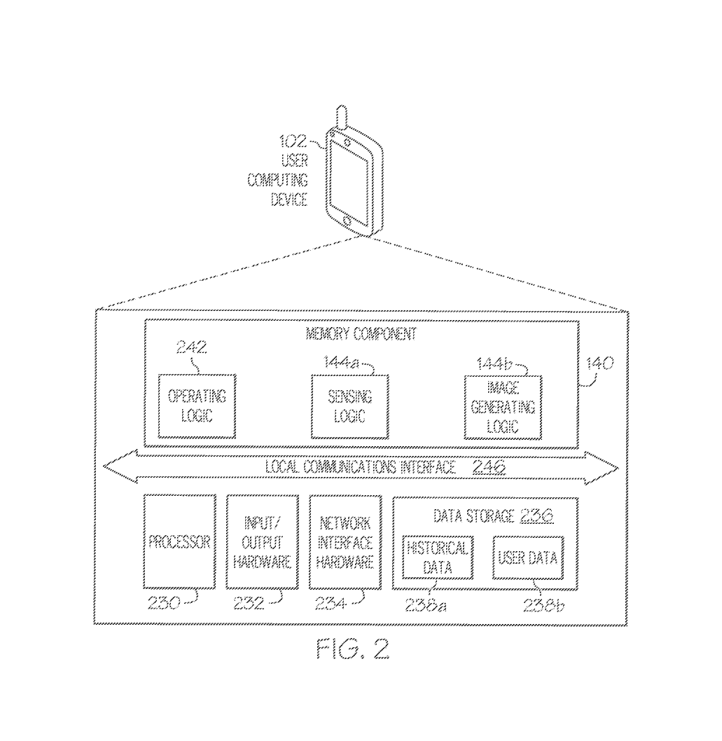

FIG. 2 depicts the user computing device 102, which may be utilized for touch screen image capture, according to embodiments disclosed herein. In the illustrated embodiment, the user computing device 102 includes a processor 230, input/output hardware 232, network interface hardware 234, a data storage component 236 (which stores historical data 238a, user data 238b, and/or other data), and the memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the user computing device 102 and/or external to the user computing device 102.

Additionally, the memory component 140 may store operating logic 242, the sensing logic 144a, and the image generating logic 144b. The sensing logic 144a and the image generating logic 144b may each include a plurality of different pieces of logic, each of which may be embodied as a computer program, firmware, and/or hardware, as an example. A local communication interface 246 is also included in FIG. 2 and may be implemented as a bus or other communication interface to facilitate communication among the components of the user computing device 102.

The processor 230 may include any processing component operable to receive and execute instructions (such as from the data storage component 236 and/or the memory component 140). The input/output hardware 232 may include and/or be configured to interface with a monitor, positioning system, keyboard, touch screen (such as the touch screen 104), mouse, printer, image capture device, microphone, speaker, gyroscope, compass, and/or other device for receiving, sending, and/or presenting data. The network interface hardware 234 may include and/or be configured for communicating with any wired or wireless networking hardware, including an antenna, a modem, LAN port, wireless fidelity (Wi-Fi) card, WiMax card, mobile communications hardware, and/or other hardware for communicating with other networks and/or devices. From this connection, communication may be facilitated between the user computing device 102 and other computing devices.

The operating logic 242 may include an operating system and/or other software for managing components of the user computing device 102. Similarly, as discussed above, the sensing logic 144a may reside in the memory component 140 and may be configured to cause the processor 230 to sense touch inputs from the touch screen sensors and determine a size, shape, and position of those touch inputs. Similarly, the image generating logic 144b may be utilized to generate an image from the touch inputs, as well as generate user interfaces and user options. Other functionality is also included and described in more detail, below.

It should be understood that the components illustrated in FIG. 2 are merely exemplary and are not intended to limit the scope of this disclosure. While the components in FIG. 2 are illustrated as residing within the user computing device 102, this is merely an example. In some embodiments, one or more of the components may reside external to the user computing device 102. It should also be understood that, while the user computing device 102 in FIG. 2 is illustrated as a single device, this is also merely an example. In some embodiments, the sensing logic 144a and/or the image generating logic 144b may reside on different devices. Additionally, while the user computing device 102 is illustrated with the sensing logic 144a and the image generating logic 144b as separate logical components, this is also an example. In some embodiments, a single piece of logic may cause the user computing device 102 to provide the described functionality.

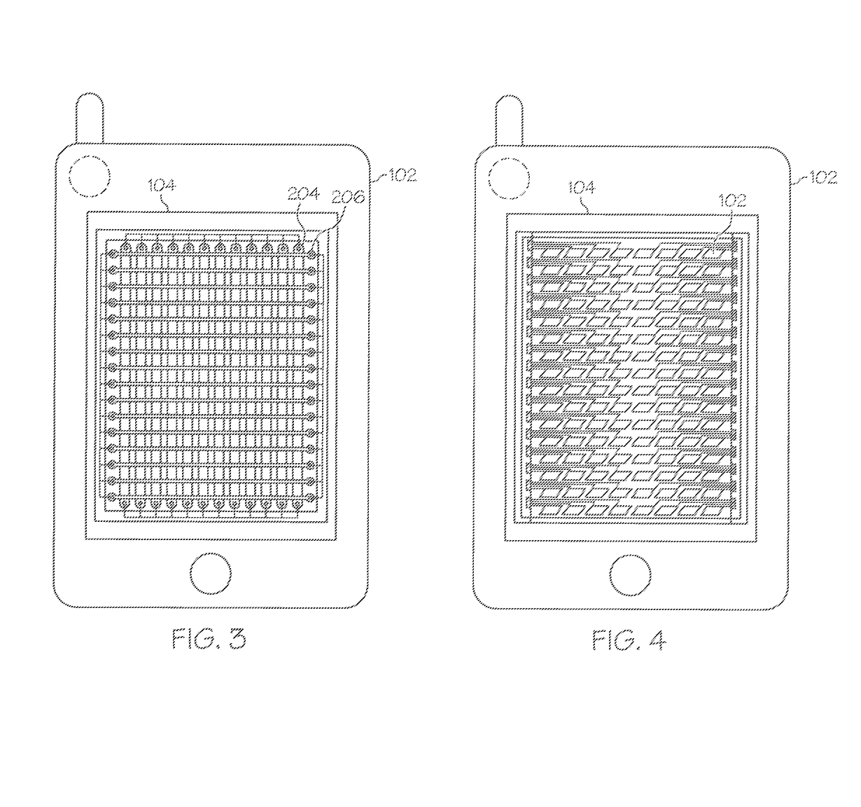

FIG. 3 depicts the user computing device 102, utilizing a mutual capacitive touch screen configuration, according to embodiments disclosed herein. As illustrated, the touch screen 104 may be configured as a mutual capacitive touch screen, which may include a glass substrate, one or more sensing lines 204, one or more driving lines 206, a bonding layer, and a protective coating. The driving lines 206 may be configured to drive current through the touch screen 104. The sensing lines 204 may be configured to detect current that is generated when a user touches the touch screen 104. More specifically, when the user touches the touch screen 104, the current is disrupted, such that the sensing lines 204 can detect the size, shape, and position of the input. Depending on the particular embodiment, the touch screen 104 may be configured as a capacitive touch screen, a resistive touch screen, an electrical current touch screen, a vibrational touch screen, and/or utilize other technology for performing the described functionality.

FIG. 4 depicts the user computing device 102, utilizing a self capacitive touch screen configuration, according to embodiments disclosed herein. As illustrated, in the self capacitive configuration, the touch screen 104 may include a single layer of electrodes 402 that are arranged in an array. This embodiment may additionally include a glass substrate, a bonding layer, capacitance sensing circuitry, and a protective layer. However, in this embodiment, the array of electrodes may utilize sensing circuitry (such as capacitive sensing circuitry, resistive sensing circuitry, vibrational sensing circuitry etc.) to detect the size, shape, and position of the touch input.

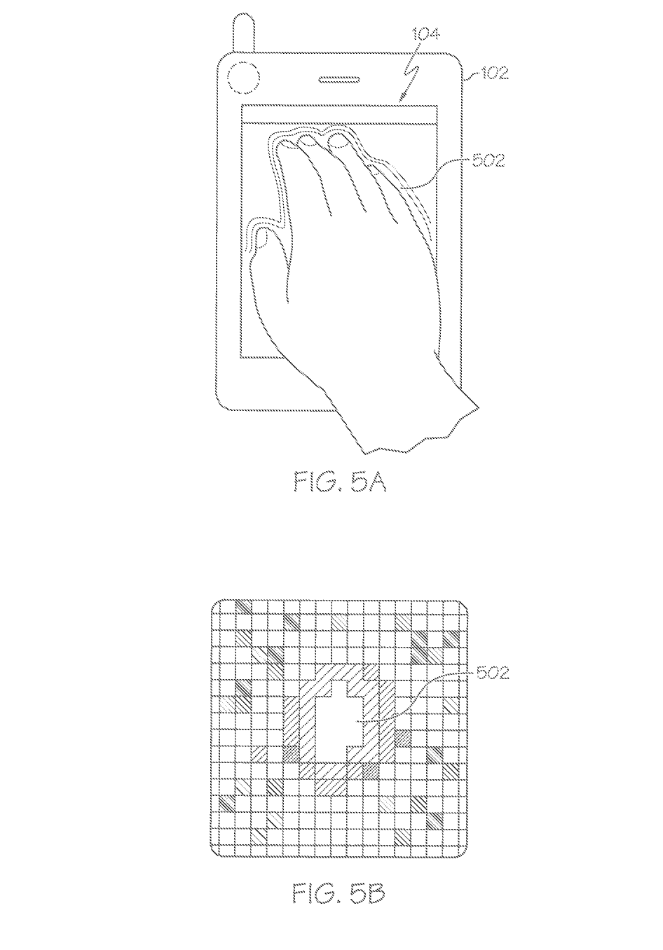

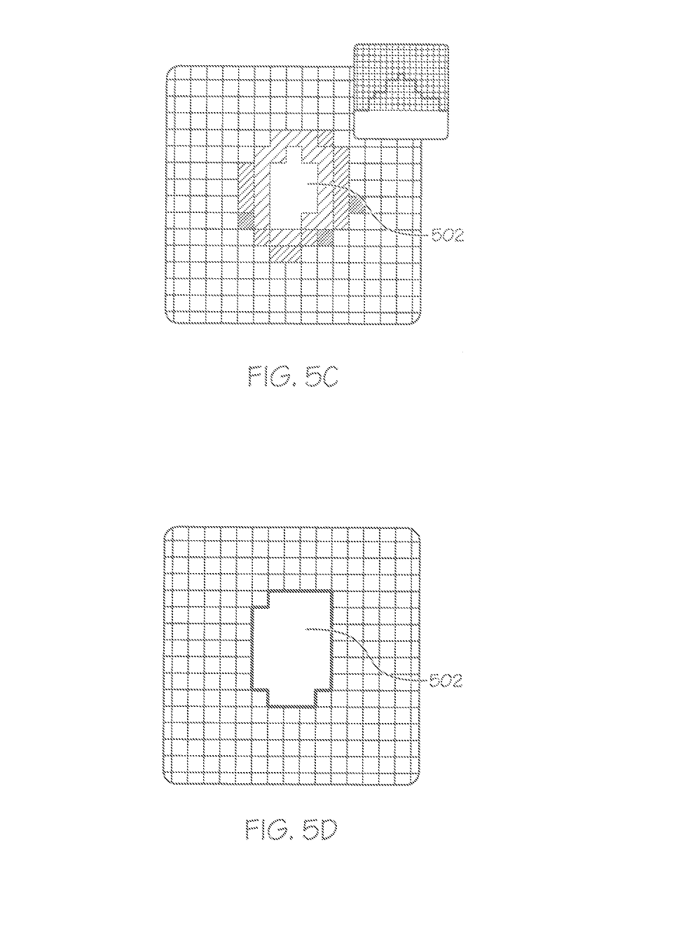

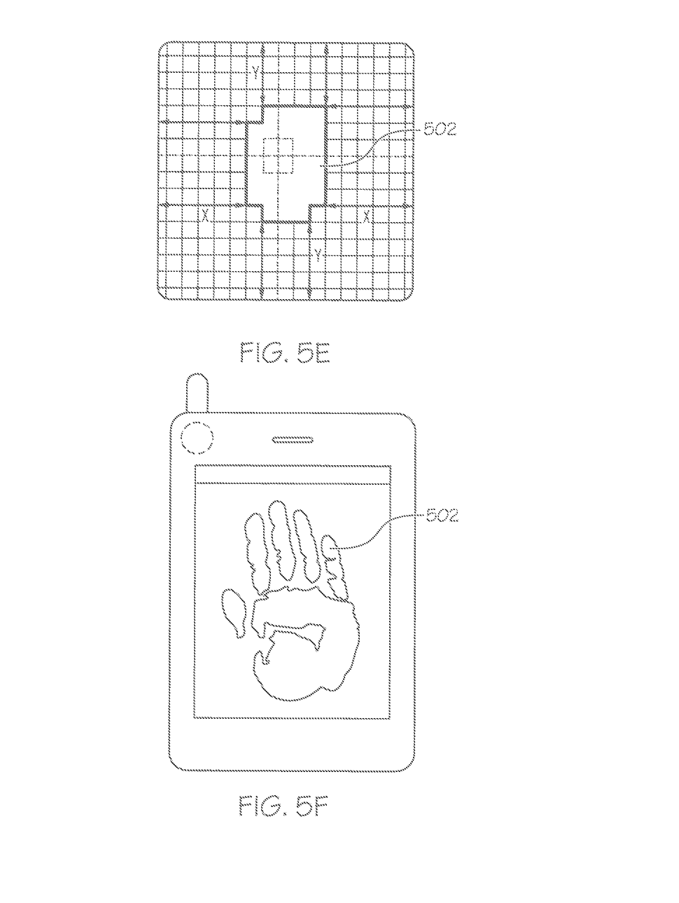

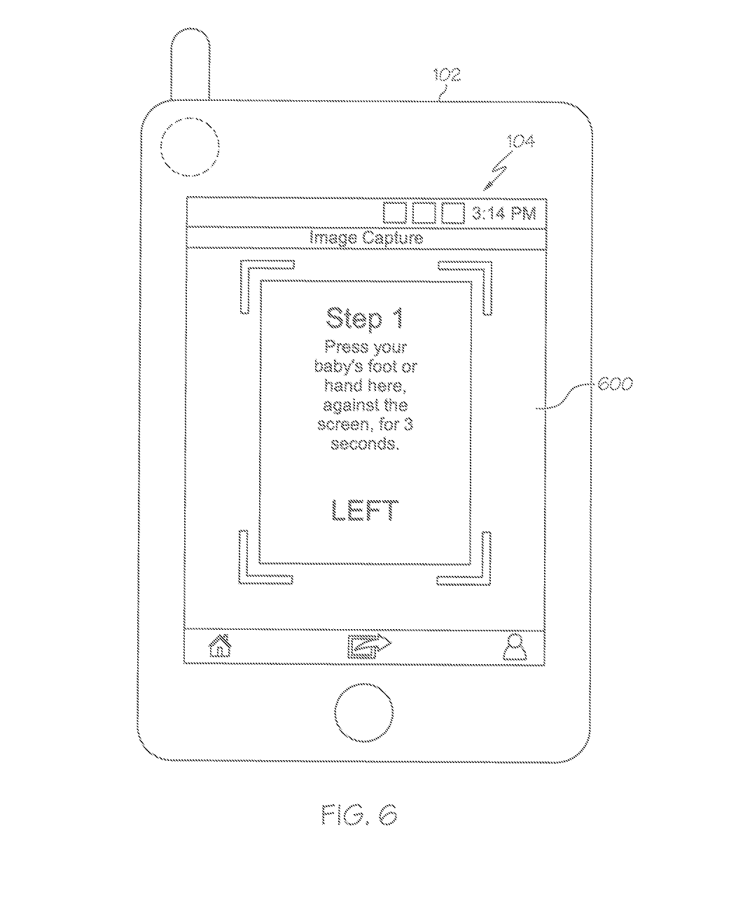

FIGS. 5A-5F depict a visual representation of a process for the touch screen 104 to determine an input, according to embodiments disclosed herein. As illustrated in FIG. 5A, a user may touch the touch screen 104 with a multi-point touch 502. As discussed above, the touch screen 104 may include one or more sensing areas, which can detect the multi-point touch 502. As illustrated in FIG. 5B, at a single sensor that is located at a predetermined position, the user computing device 102 can utilize a portion of data received from the touch screen 104 to determine a size, shape, and position of at least a portion of the multi-point touch 502. As illustrated in FIG. 5C, from this information, the user computing device 102 can remove noise and other undesired input received. In FIG. 5D, pressure points are measured to identify where the touch actually occurred. In FIG. 5E, once the touch area is established, the size, shape, and location may be determined.

As the examples from FIGS. 5A-5E establish the size, shape, and location of a single point touch, when the user is utilizing a multi-point touch 502, this (or a similar) process may be utilized for a plurality of points of the multi-point touch 502. Additionally, once each of the plurality of points of the multi-point touch 502 has been analyzed, the user computing device 102 can piece each touch together to determine a total size and a total shape of the multi-point touch 502. As illustrated in FIG. 5F, once the total size and a total shape are determined, the user computing device 102 can display the image of the total imprint left by the multi-touch input.

Additionally, in some embodiments, the touch screen 104 may be configured to simply determine a total size, shape, and location of a multi-touch input, such as a handprint, footprint, lip print, nose print, ear print, paw print, etc. In such embodiments, the process discussed with regard to FIGS. 5A-5F may be extrapolated to the multi-touch input.

FIG. 6 depicts a user interface 600 for a first touch screen image capture, according to embodiments disclosed herein. As illustrated, the user computing device 102 may provide the user interface 600 in the touch screen 104. Included in the user interface 600 is an area for a multi-point input (such as a foot imprint, a hand imprint, nose imprint, lip imprint, paw imprint, etc.). As also indicated, the user interface 600 may specifically ask the user for a particular body part to place on the touch screen 104 (in this example, a left foot or hand). With this information, the user computing device 102 can further anticipate and thus more accurately determine the shape of the imprint for providing an accurate image to the user.

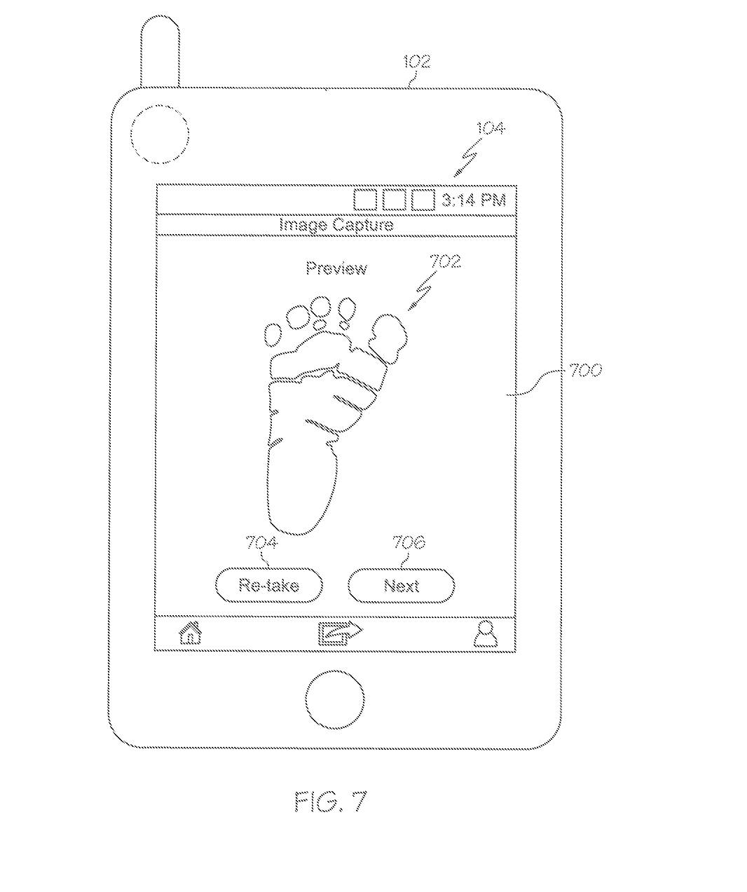

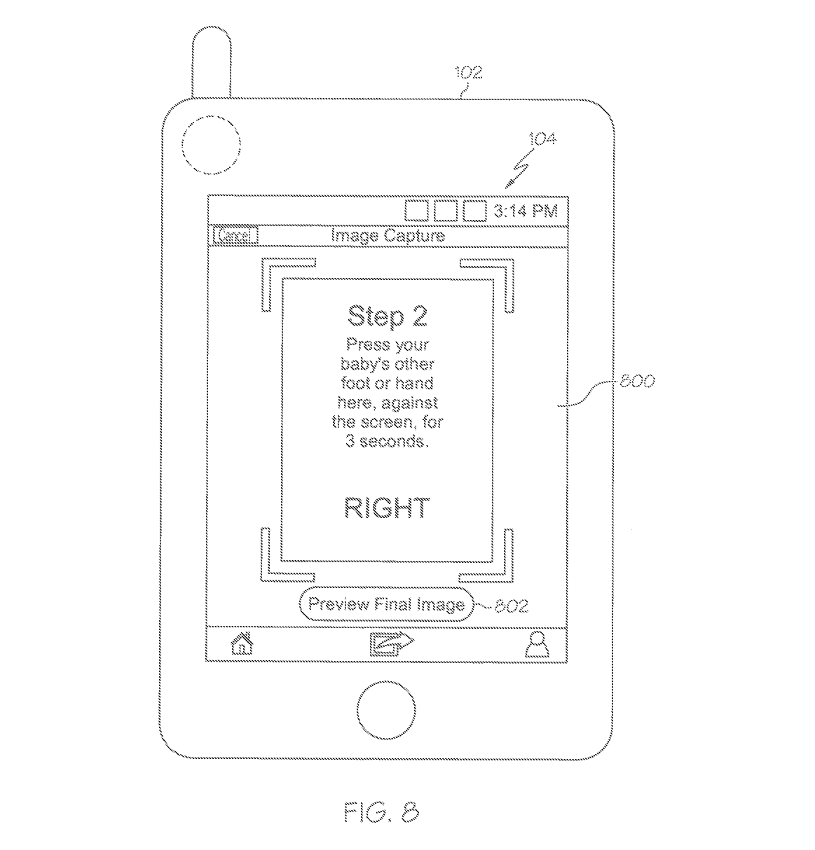

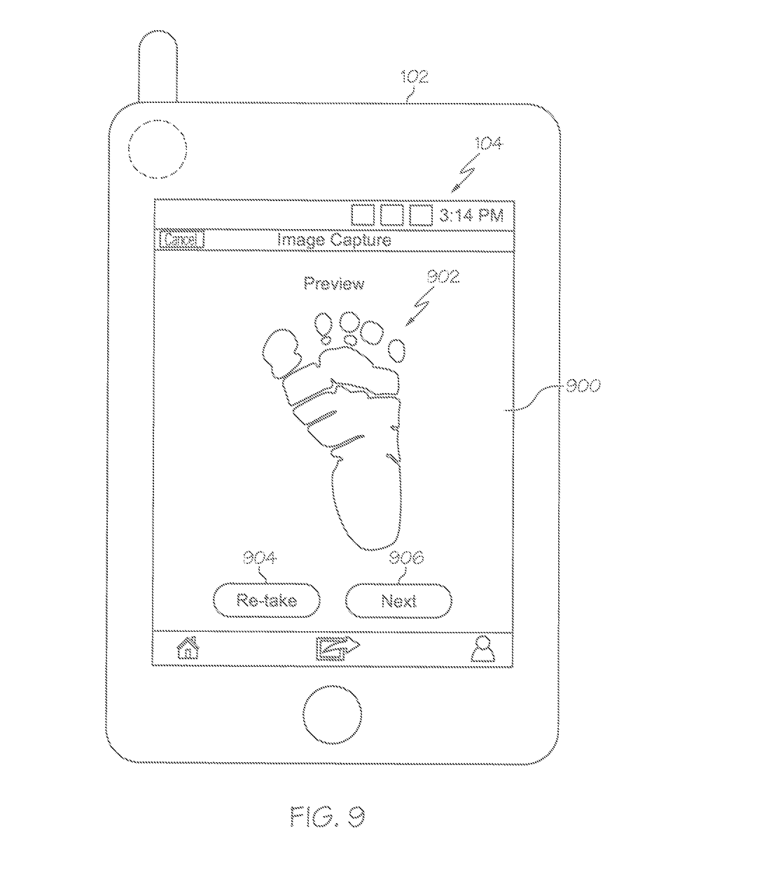

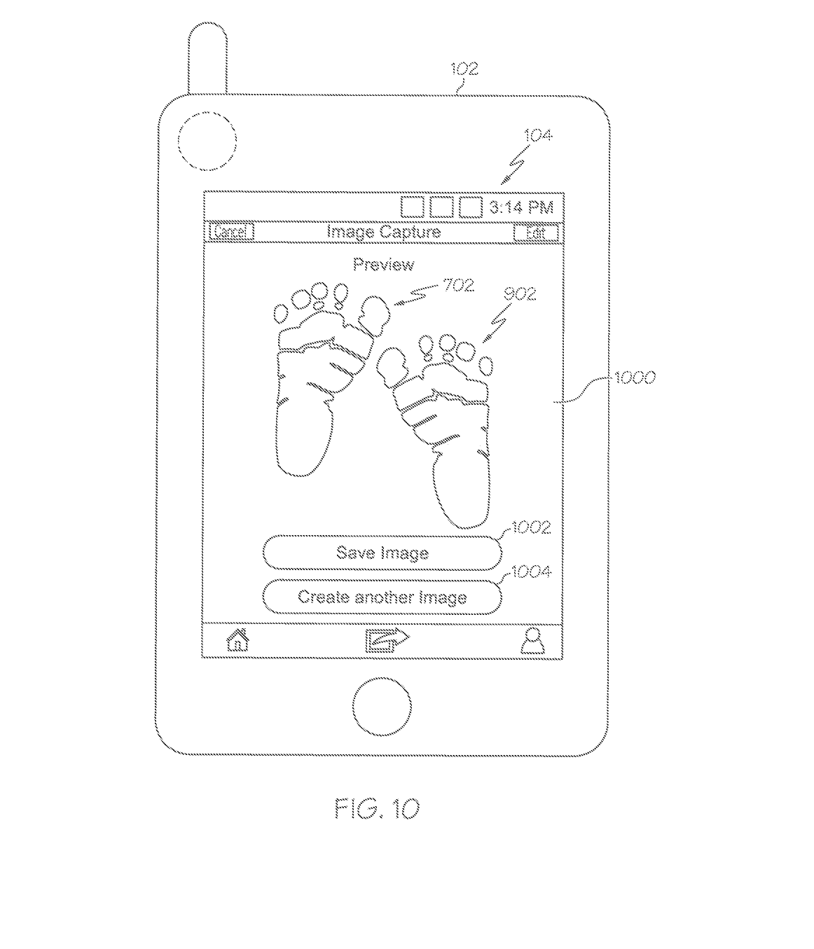

FIG. 7 depicts a user interface 700 for receiving a first imprint of a foot, according to embodiments disclosed herein. As illustrated, the user interface 700 may provide the image 702 of the imprint left by the multi-point touch. Also included are a re-take option 704 and a next option 706. The re-take option 704 may return the user computing device 102 to the user interface 600 (FIG. 6) for re-taking the multi-point touch. The next option 706 causes the user computing device 102 to proceed to a next user interface 800, described with reference to FIG. 8.

FIG. 8 depicts a user interface 800 for a second touch screen image capture, according to embodiments disclosed herein. As illustrated, the user interface 800 may include an option for receiving a second body part from the user. The second body part may be specifically requested (in this example, a right foot or hand). More specifically, the user computing device 102 may be configured to determine the body part received in FIGS. 6 and 7 (e.g. a left foot) and thus request a corresponding body part in FIG. 8 (e.g., a right foot). Once the user has complied with the request in the user interface 800, the user may select a review final image option 802.

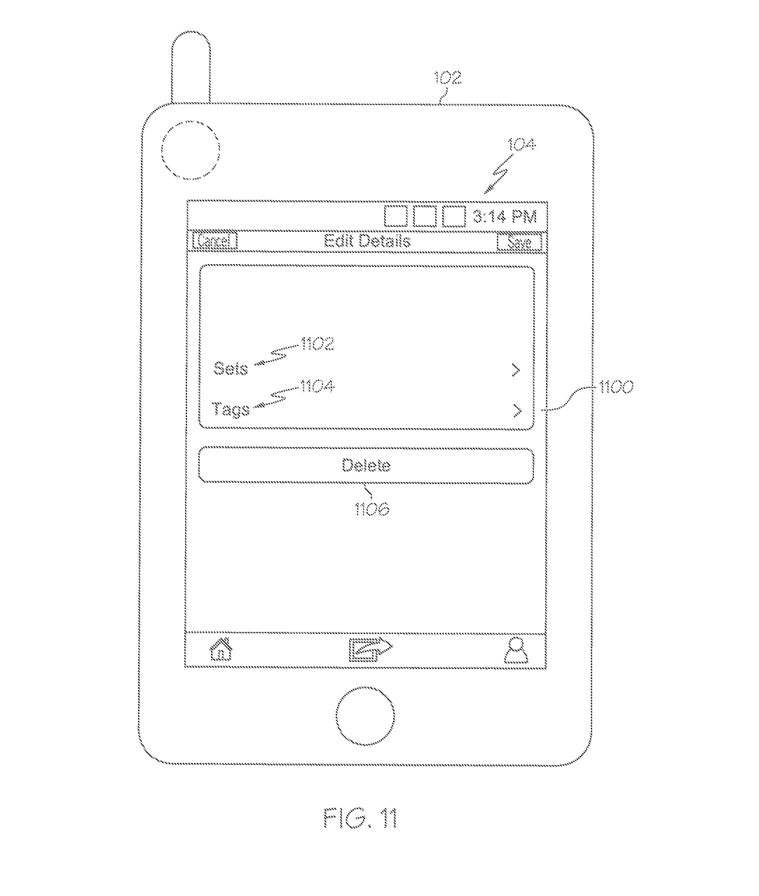

FIG. 9 depicts a user interface 900 for providing a second imprint of a foot, according to embodiments disclosed herein. As illustrated, in response to selection of the review final image option 802 from FIG. 8, the user interface 900 may be provided. The user interface 900 may provide an image 902 derived from the multi-touch input request in FIG. 8, as well as a re-take option 904 and a next option 906. The re-take option 904 may return the user to the user interface 800 (FIG. 8) for re-taking the multi-point input. The see next option 906 may proceed to the next user interface 1000 (FIG. 10) for viewing the final image.

It should be understood that in some embodiments, the user interface 700 (FIG. 7) may also include a finish option, which can bypass the user interface 900. More specifically, if the user only wishes to take an imprint of a left foot, the user may capture the left foot in FIGS. 6 and 7, and then select the finish option. The user computing device 102 may then proceed to FIG. 10.

FIG. 10 depicts a user interface 1000 for including the imprint of a first foot with the imprint of the second foot, according to embodiments disclosed herein. As illustrated, the image 702 (from FIG. 7) and the image 902 (from FIG. 9) may be combined and provided as a single image to provide a visual comparison of the two images. If the images are acceptable, the user may select a save image option 1002. Also included is a create another image option 1004 for creating another multi-point input image.

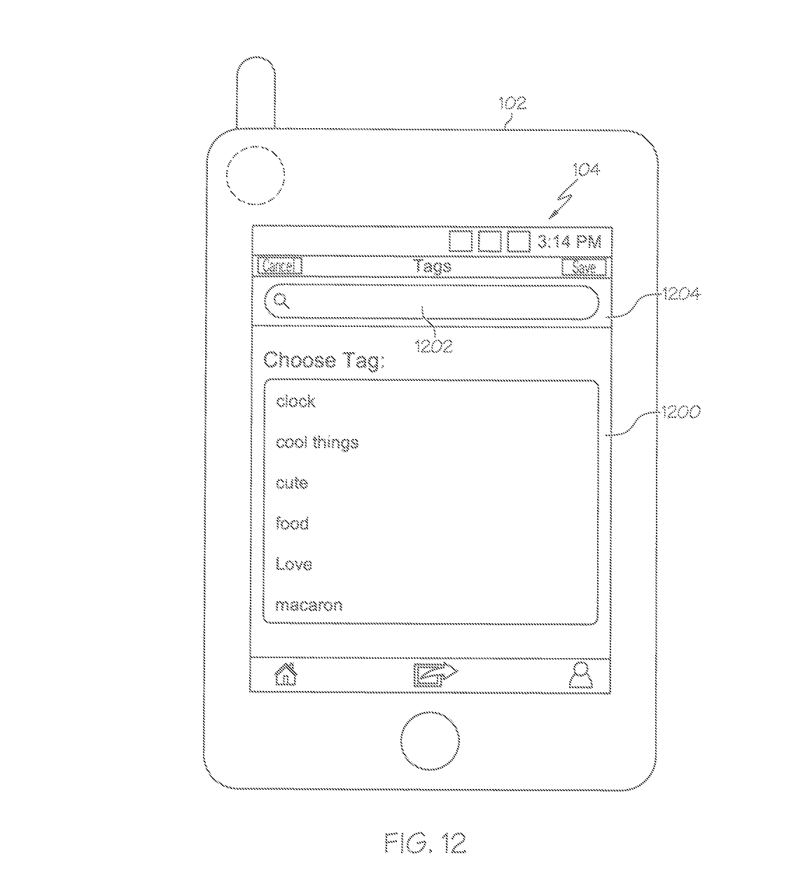

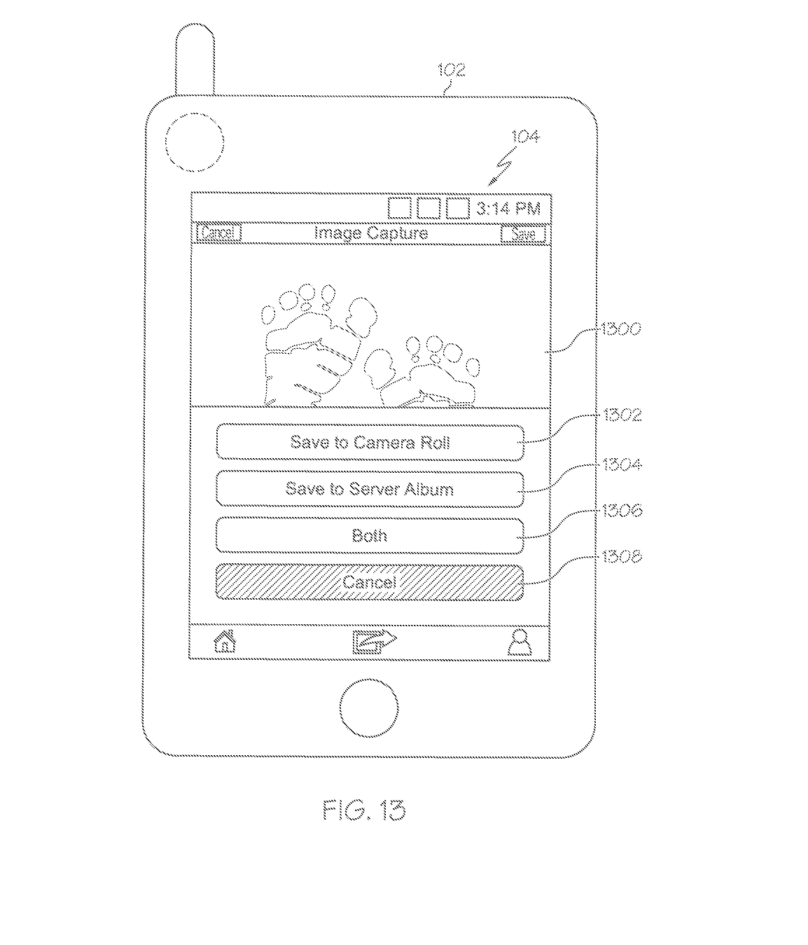

FIG. 11 depicts a user interface 1100 for tagging a touch screen image capture, according to embodiments disclosed herein. As illustrated, in response to selection of the save image option 1002 from FIG. 10, the user may be provided with a sets option 1102 to organize the image with a set of other images. Also included is a tag option 1104 for tagging the image with a predetermined tag, as discussed with reference to FIG. 12. A delete option 1106 is also included. In response to selection of the delete option 1106, the image may be deleted from the user computing device 102.

FIG. 12 depicts a user interface 1200 for assigning a particular tag to a touch screen image capture, according to embodiments disclosed herein. As illustrated, in response to selection of the tag option 1104 (FIG. 11), a plurality of tags may be provided for the user to tag the image from FIG. 10. Also included is a search function 1202 for searching for additional tags not currently displayed in the user interface 1200.

It should be understood that while the user interface 1200 includes a predetermined list of tags, in some embodiments, the user may create a user-defined category for tagging the image. In such embodiments, the user may be provided with an option to create and name the tag. The user-created tag may be listed in the user interface 1200 and/or elsewhere, depending on the embodiment.

It should also be understood that in some embodiments, the user computing device 102 may also provide options to enhance the image, outline a boundary of the image, annotate the image, name the image, and/or date the image. As an example, if the image is unclear, the user computing device 102 may provide an option to improve the resolution of the image, add color to the image, and/or provide other enhancements. Similarly, the boundary of the image may be determined and that boundary may be outlined. The image may additionally be annotated, such that information may be provided with the image. On a similar note, the image may be named and/or dated to identify the image.

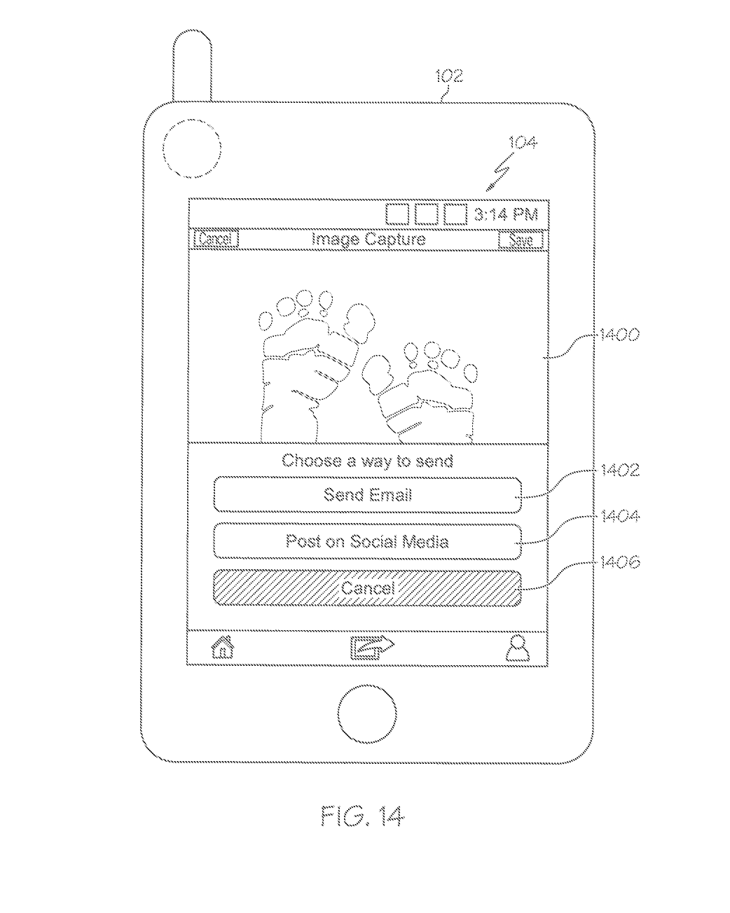

FIG. 13 depicts a user interface 1300 for providing saving options, according to embodiments disclosed herein. As illustrated, in response to creating a tag for the image, the user interface 1300 may be provided for saving the image. As illustrated, the user interface 1300 may include a save to camera roll option 1302, a save to server album option 1304, a both option 1306, and a cancel option 1308. The save to camera roll option 1302 may facilitate a local save of the image to the user computing device 102. The save to server album option 1304 may facilitate a save to the remote computing device 106. The both option 1306 may facilitate a save of the image to both the user computing device 102 and the remote computing device 106. The cancel option 1308 may cancel the saving process.

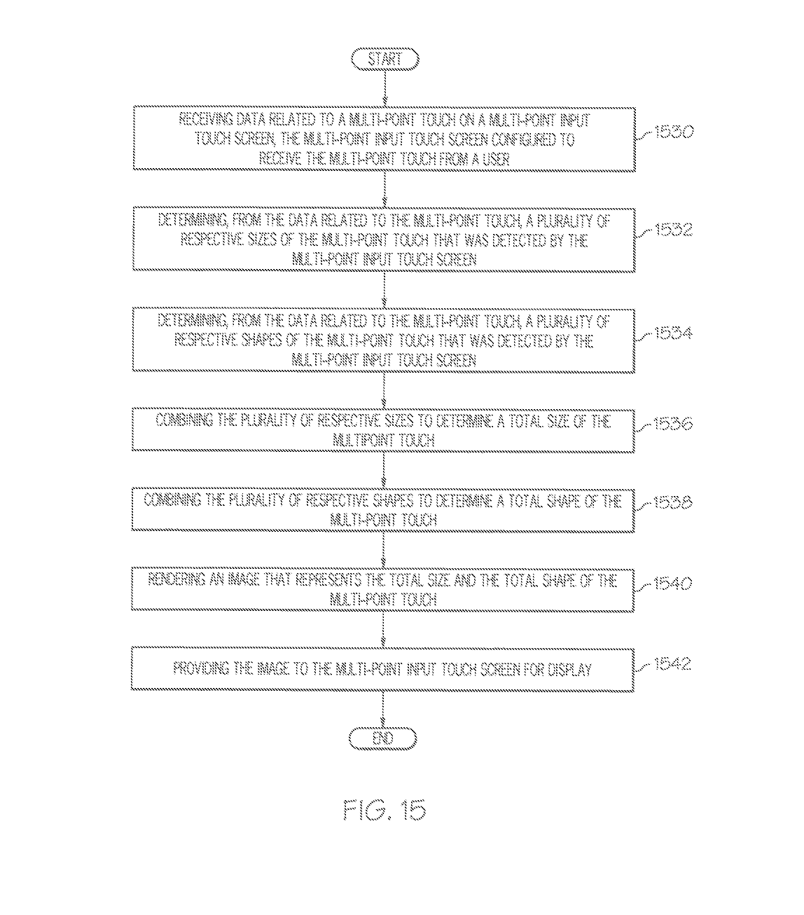

FIG. 14 depicts a user interface 1400 for providing sending options, according to embodiments disclosed herein. As illustrated, the user interface 1400 may be provided in response to saving the image in FIG. 13 and/or by selection of a user send option (not explicitly depicted). The user interface 1400 may include a send by email option 1402 for sending the image as an attachment to an email message. A post on social media option 1404 may allow the user to post the image on a social media website. A cancel option 1406 may cancel the sending operation.

FIG. 15 depicts a flowchart for touch screen image capture, according to embodiments disclosed herein. As illustrated in block 1530, data related to a multi-point touch may be received from a plurality of sensors on a multi-point input touch screen. The multi-point input touch screen may be configured to receive the multi-point touch from a user. In block 1532, a determination may be made, from the data related to the multi-point touch, regarding a plurality of respective sizes of the multi-point touch that was detected by the multi-point input touch screen. In block 1534, a determination may be made, from the data related to the multi-point touch, regarding a plurality of respective shapes of the multi-point touch that was detected by the multi-point input touch screen. In block 1536, the plurality of respective sizes may be combined to determine a total size of the multi-point touch. In block 1538, the plurality of respective shapes may be combined to determine a total shape of the multi-point touch. In block 1540, an image may be rendered that represents the total size and the total shape of the multi-point touch. In block 1542, the image may be provided to the multi-point input touch screen for display.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for touch screen image capture, comprising:
(a) a multi-point input touch screen comprising a plurality of sensors that collectively receive a multi-point touch from a user; and
(b) a memory component that stores logic that when executed by the system causes the system to perform at least the following:
(i) receive data related to the multi-point touch;
(ii) determine a total size of the multi-point touch;
(iii) determine a total shape of the multi-point touch;
(iv) render an image that represents the total size and the total shape of the multi-point touch; and
(v) provide the image to the multi-point input touch screen for display.

2. The system of claim 1, wherein the multi-point touch comprises at least one of the following: a foot imprint, a hand imprint, a nose imprint, an ear imprint, and a pet paw imprint.

3. The system of claim 1, wherein determining the total size and the total shape of the multi-point touch comprises:
(a) receiving a first portion of the data related to the multi-point touch from a first sensor of the plurality of sensors:
(b) determining a first size and a first shape of the multi-point touch for a first area that is monitored by the first sensor;
(c) receiving a second portion of the data related to the multi-point touch from a second sensor of the plurality of sensors:
(d) determining a second size and a second shape of the multi-point touch for a second area that is monitored by the second sensor;
(e) combining the first size and the second size to determine the total size; and
(f) combining the first shape and the second shape to determine the total shape.

4. The system of claim 3, wherein combining the first size and the second size to determine the total size comprises identifying a first predetermined position of the first sensor and a second predetermined position of the second sensor.

5. The system of claim 3, wherein combining the first shape and the second shape to determine the total shape comprises identifying a first predetermined position of the first sensor and a second predetermined position of the second sensor.

6. The system of claim 1, wherein the plurality of sensors are coupled to the multi-point input touch screen that comprises at least one of the following: an electrical current touch screen, a vibrational touch screen, a capacitive touch screen, and a resistive touch screen.

7. The system of claim 1, wherein the logic further causes the system to tag the image according to a user-defined category.

8. A method for touch screen image capture, comprising:
(a) receiving data related to a multi-point touch on a multi-point input touch screen, the multi-point input touch screen configured to receive the multi-point touch from a user;
(b) determining, from the data related to the multi-point touch, a plurality of respective sizes of the multi-point touch that was detected by the multi-point input touch screen;
(c) determining, from the data related to the multi-point touch, a plurality of respective shapes of the multi-point touch that was detected by the multi-point input touch screen;
(d) combining the plurality of respective sizes to determine a total size of the multi-point touch;
(e) combining the plurality of respective shapes to determine a total shape of the multi-point touch;
(f) rendering an image that represents the total size and the total shape of the multi-point touch; and
(g) providing the image to the multi-point input touch screen for display.

9. The method of claim 8, wherein the multi-point touch comprises at least one of the following: a foot imprint, a hand imprint, a nose imprint, an ear imprint, and a pet paw imprint.

10. The method of claim 8, wherein combining the plurality of respective sizes to determine the total size comprises identifying a position of each touch on the multi-point touch.

11. The method of claim 8, wherein combining the plurality of respective shapes to determine the total shape comprises a position of each touch on the multi-point touch.

12. The method of claim 8, wherein the multi-point input touch screen comprises at least one of the following: an electrical current touch screen, a vibrational touch screen, a capacitive touch screen, and a resistive touch screen.

13. The method of claim 8, further comprising tagging the image according to a user-defined category.

14. The method of claim 8, further comprising providing at least one of the following: a first user option to save the image locally, a second user option to save the image remotely, and a third user option to save the image both locally and remotely.

15. A non-transitory computer-readable medium that stores a program that when executed by a computing device causes the computing device to perform at least the following:
(a) receive data related to a multi-point touch from a plurality of sensors on a multi-point input touch screen, the multi-point input touch screen configured to receive the multi-point touch from a user;
(b) determine, from the data related to the multi-point touch, a plurality of respective sizes of the multi-point touch that was detected by each of the plurality of sensors;
(c) determine, from the data related to the multi-point touch, a plurality of respective shapes of the multi-point touch that was detected by each of the plurality of sensors;
(d) combine the plurality of respective sizes to determine a total size of the multi-point touch, wherein combining the plurality of respective sizes comprises utilizing a predetermined position of each of the plurality of sensors;
(e) combine the plurality of respective shapes to determine a total shape of the multi-point touch, wherein combining the plurality of respective shapes comprises utilizing the predetermined position of each of the plurality of sensors;
(f) render a first image that represents the total size and the total shape of the multi-point touch; and
(g) provide the first image to the multi-point input touch screen for display.

16. The non-transitory computer-readable medium of claim 15, wherein the multi-point touch comprises at least one of the following: a foot imprint, a hand imprint, a nose imprint, an ear imprint, and a pet paw imprint.

17. The non-transitory computer-readable medium of claim 15, wherein the program further causes the computing device to add a second image to the first image to provide a visual comparison of the multi-point touch and the second image.

18. The non-transitory computer-readable medium of claim 15, wherein the program further causes the computing device to provide at least one of the following: a first user option to save the first image locally, a second user option to save the first image remotely, and a third user option to save the first image both locally and remotely.

19. The non-transitory computer-readable medium of claim 15, wherein the multi-point input touch screen comprises at least one of the following: an electrical current touch screen, a vibrational touch screen, a capacitive touch screen, and a resistive touch screen.

20. The non-transitory computer-readable medium of claim 15, wherein the program further causes the computing device to tag the first image according to a user-defined category.
